(19) United States
(12) Patent Application Publication
(10) Pub. No.: US 2006/0168189 A1
(43) Pub. Date: Jul. 27, 2006

(54) Advanced IPMI system with multi-message processing and configurable capability and method of the same

(75) Inventor: Shih-yuan Huang, Keelung City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/392,289

(22) Filed: Mar. 29, 2006

Related U.S. Application Data
(63) Continuation-in-part of application No. 10/711,342, filed on Sep. 13, 2004.

(51) Int. Cl. G06F 15/173

(52) U.S. Cl. 709/223

(57) ABSTRACT

An advanced intelligent platform management interface (IPMI) system with multi-message processing and configurable capability, optimally used among message sources, the IPMI system is disclosed. The IPMI system includes a sensor unit having an electrically erasable programmable read only memory (EEPROM) which stores a sensing event of a physical change in a host system, a cache unit for accessing and storing the sensing event in the EEPROM of the sensing unit, and a memory control unit for detecting whether a new sensing event is stored in the cache unit, and for controlling the cache unit to store the new detected sensing event.

### CROSS REFERENCE TO RELATED APPLICATION

This is a continuation-in-part of a U.S. patent application Ser. No. 10/711,342, filed on Sep. 13, 2004.

### BACKGROUND OF INVENTION

1. Field of the Invention

The invention relates to an advanced IPMI system with multi-message processing and configurable capability and the method of the same, and more particularly, to an IPMI system for server management and the method of the same.

2. Description of the Prior Art

As known in the art, when remote servers, such as telecommunications equipment, computer stations, and especially ISP servers are out of order, a system manager must go to the server's location in order to fix the situation. This requires much manpower and time. To solve this issue, management technology for remote servers, such as the intelligent platform management interface (IPMI), has gradually been developed.

The IPMI mainly comprises a hardware structure, i.e., a micro-controller having a baseboard management controller (BMC) and firmware embedded in the BMC. The IPMI is actually a server management subsystem operating independently of server hardware such as the central process unit (CPU) and the basic input/output system (BIOS), and software such as the operating system (OS) and the system management software (SMS). The IPMI controls the system management software and the interface of the platform management hardware, especially while the CPU, the BIOS, and/or the OS of the server are failing.

Most of the BMC micro-controllers are integrated with A/D converters for monitoring voltage, fan speed, IO status and bus status. As a watchdog, the IPMI system detects the failure of the CPU, BIOS, OS, or application program of the servers. The IPMI further provides a platform event filter (PEF) to fix the failure, automatically or follow the instructions from the operating terminal. Moreover, the IPMI automatically provides system status detection of software/hardware of the servers, an event diary log, system rebooting control, automatic alarm for the event, and auto-system control (such as system power off). For example, the BMC micro-controller of the IPMI utilizes an I²C digital sensor for polling the measurement of the host system in order to monitor the system voltage, temperature, and fan speed variations of the remote host system. The IPMI then decides whether the monitored data exceeds the default range and sends an I²C sensing data (an IPMI message) through an intelligent platform management bus (IPMB) or communicates with the host system through a system management bus (SMBus) interface. Any system exception will be immediately recorded in a system event log (SEL) and the IPMI will ask the PEF to find a response action corresponding the exception, for instance, cutting off the power supply, re-plugging in the power, rebooting, sending/broadcasting a warning, and so forth.

The IPMI can further allow a remote operating terminal for transmitting through a local area network (LAN) an IPMI message packet which is conforming to remote mail checking protocol (RMCP) and user datagram protocol/internet protocol (UDP/IP). The IPMI may also provide the function of remotely monitoring/controlling servers with serial messages of serial modem (such as a universal asynchronous receiver/transmitter, UART) interface protocol in order to access the monitored data for immediate fault correction of a critical event. When the temperature of the server exceeds a predetermined value significantly, the IPMI keeps tracking the event log for future reference, automatically exterminating the problem by speeding up the system fan for more heat dissipation and broadcasting an alert on local area network (LAN), that is, sending a simple network management protocol (SNMP) trap of platform event traps (PET) or an alert of a serial modem to the remote operating terminal. Once the operating terminal, host system, or BMC controller of the IPMI receives/sends an IPMI channel message, the firmware of the IPMI may process/respond through some different fixed channels, such as intelligent platform management bus (IPMB), keyboard control style application interface (KCS), intelligent chassis management bus (ICMB), universal asynchronous receiver/transmitter (UART), or local area network (LAN).

What needs to be noticed is that the IPMI system accesses the hardware data by generating a sensor command such as ‘Get Sensor Reading’ through a sensor management unit such as a management controller, rather than directly access the hardware data of a sensor unit such as an I²C sensor.

However, the firmware design of the generic IPMI is still not perfect and some drawbacks exist:

(1) As an IPMI message passes through a module or a unit of the firmware, the module or unit itself needs to allocate a dedicated local memory in order to copy the passing IPMI message for later passing, queuing, using, and implementing. This not only requires higher memory cost but also lowers the IPMI performance for increasing the overall system execution time since reading/copying the IPMI message occurs in almost all steps.

(2) The execution unit of the IPMI firmware known in the prior art deals only with one IPMI message at a time, and the rest of the IPMI messages wait in a queue for the next response, lowering even more IPMI performance.

(3) Because of the interdependence of the IPMI firmware units known in the prior art, it is unlikely to replace any individual unit if the operator needs some changes of the firmware functions. Nothing can be changed unless the overall IPMI structure is rearranged; therefore, no expandability and programmability.

(4) The IPMI firmware known in the prior art requires a sensor management unit such as a management controller to access a sensing event in an electrically erasable programmable read only memory (EEPROM) of a sensor unit. However, the access speed of the EEPROM is pretty low. The EERPOM might be busy and then jammed in the data bus if lots of IPMI messages are in queue. Especially when the EEPROM shares the data bus with other devices, lots of data collisions will make the system even more sluggish.

(5) The IPMI firmware known in the prior art is not able to automatically coordinate with too many different types of hardware such as BMC controllers or different types of operating systems (OS).

### SUMMARY OF INVENTION

It is therefore an objective of the claimed invention to provide an advanced intelligent platform management interface (IPMI) system with multi-message processing and configurable capability. The advanced (IPMI) system includes a sensor unit having an programmable memory device which stores a sensing event of a physical change in a host system, a cache unit for accessing and storing the sensing event in the programmable memory device of the sensor unit, and a memory control unit for detecting the sensing event storing in the cache unit, and for controlling the cache unit to store the detected sensing event.

The cache unit is a random access memory (RAM) and the sensor unit is an I²C sensor.

It is another objective of the claimed invention to provide a method for the advanced IPMI system. The method includes the steps of:
receiving a request from at least one message source for obtaining a sensing event of a physical change in a host system;
detecting whether the sensing event is stored in a cache unit;
reading the sensing event from the cache unit if the sensing event is stored in the cache unit; and
generating a message in response to the detection of the sensing event.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a composition structure diagram describing an internal structure of an advanced IPMI system as the preferred embodiment.

FIG. 2 illustrates a flowchart describing an execution method of an IPMI system as the preferred embodiment.

FIG. 3 illustrates a flowchart describing an execution method of an IPMI system as the preferred embodiment that further reveals detailed information of the execution of an IPMI message between an IPMI message subsystem and an IPMI core subsystem.

FIG. 4 illustrates a flowchart describing an execution method of an IPMI system as the preferred embodiment that further reveals the execution procedure of an IPMI message by a memory control unit.

### DETAILED DESCRIPTION

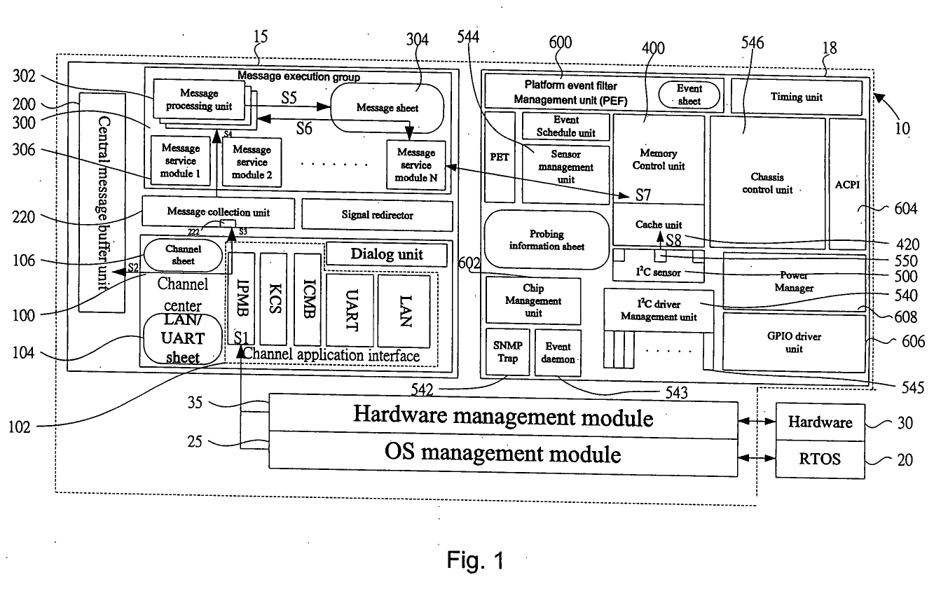

FIG. 1 shows the main structure of an exemplary embodiment of a present invention advanced intelligent platform management interface (IPMI) system 10, optimally used among message sources, i.e. a host system and an operating terminal (not shown). The IPMI system 10 comprises an IPMI message subsystem 15 having a central message buffer unit 200, and an IPMI core subsystem 18. The central message buffer unit 200 includes a memory block (not shown) for temporarily storing each IPMI message sent by said message sources and providing a pointer (not shown) to a corresponding address. The pointer is utilized by said subsystems for transmission in order to reduce the time of reading IPMI messages, thus raising the performance of the advanced IPMI system 10.

The IPMI message subsystem 15 further comprises a channel center 100, a message collection unit 220, and a message execution group 300. The channel center 100 has a plurality of channel application interfaces 102 and programmable-configured sheets such as LAN/UART sheet 104 and channel sheet 106. The plurality of channel application interfaces 102 at least includes an intelligent platform management bus (IPMB) application interface, a keyboard control style application interface (KCS), an intelligent chassis management bus (ICMB) application interface, a universal asynchronous receiver/transmitter (UART) application interface, and a local area network (LAN) application interface. Each channel application interface 102 stands for a specific channel application program interface (API). For example, the IPMI application interface works for receiving from/sending to the message sources a corresponding IPMI message (such as step S1 in FIG. 1). When verifying the received IPMI message, the channel application interface 102 then stores the IPMI message in the central message buffer unit 200 (such as step S2 in FIG. 1), provides a pointer to the corresponding address, and transmits the pointer to the message collection unit 220 (such as step S3 in FIG. 1). The programmable-configured sheets such as channel sheet 106 and LAN/UART sheet 104 connect respectively with the channel application interfaces 102 for user definition, providing the function of modular switch and renewal. The LAN/UART sheet 104 maintains the regulation of the username and password from those who communicate through UART and LAN application interfaces.

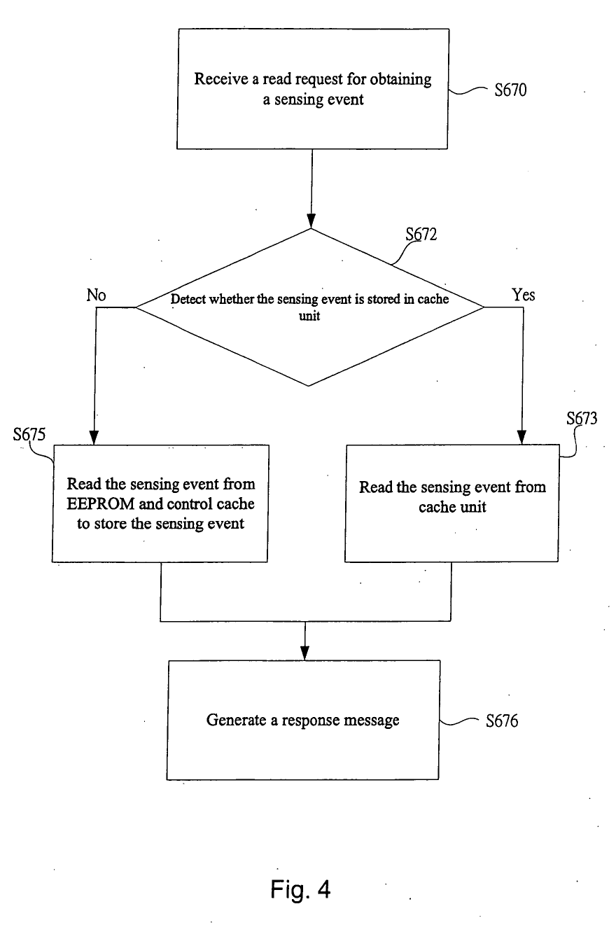

The message collection unit 220 has a queue 222 to collect in queue the pointers transmitted by the channel application interfaces 102 and forwards them to the message execution group 300 (such as step S4 in FIG. 4).

The message execution group 300 further comprises a plurality of programmable-configured message processing units 302, a programmable-configured message sheet (i.e. the message sheet 304), and a plurality of message service modules 306. Each message service module 306 designates correspondingly every IPMI message a default execution procedure, i.e. a routine. The message sheet 304 allows the user to predefine a corresponding relation between every IPMI message and the message service module 306. The plurality of programmable-configured message processing units 302, i.e. threads, can be pre-configured and installed according to user's need to concurrently multi-process the IPMI messages, look up the corresponding message service module 306 of the message sheet 304 according to every IPMI message (such as step S5 in FIG. 1) and initiate the execution procedure of the message service module 306 (such as step S6 in FIG. 1).

As FIG. 1 shows, the IPMI core subsystem 18 includes a plurality of application units such as a simple network management protocol (SNMP) trap 542, an event daemon 543, an I²C driver management unit 540, a sensor manager 544, a chassis controller 546, a platform event filter (PEF) management unit 600, a chip management unit 602, an advanced configuration and power interface (ACPI) 604, a basic general purpose input/output (GPIO) driver unit 606, and a power manager 608. Each application unit equips the IPMI system 10 with a specific function, e.g., the memory control unit 400 accesses the memory. When an application unit of the IPMI core subsystem 18 receives the direction of the execution procedure of the IPMI message subsystem 15, the application unit executes the IPMI message. Meanwhile, the message processing unit 302 of the message execution group 300 transmits the IPMI message pointer to the application units (such as the memory control unit 400) of the IPMI core subsystem 18 for execution through the message service modules 306 (such as step S7 in FIG. 1). Then the application unit reads and processes the IPMI message from the central message buffer unit 200 according to the pointer, generates a response message after the execution of the IPMI message, and then generates a response pointer to a corresponding address for temporary storage of the response message in the central message buffer unit 200.

The IPMI core subsystem 18 transmits the response pointer back to the original message processing unit 302 of the message execution group 300 of the IPMI message subsystem 15 for releasing the allocated address of the IPMI message in the central message buffer unit 200, and next transmits the response pointer to the original channel application interface 102, such as IPMB application interface, for allowing the channel application interface 102 to read a corresponding response message from the central message buffer unit 200 and send it back to the message sources.

The claimed advanced IPMI system 10 further comprises an operating system (OS) management module 25 having multiple specific mapping functions for communicating with different types of real time operating system (RTOS) 20, allowing the advanced IPMI system 10 to function with different OS. The claimed advanced IPMI system 10 further comprises a hardware management module 35 having a plurality of driver units for communicating with different hardware 30 such as baseboard management controllers (BMC), allowing the advanced IPMI system 10 to function in different hardware environments. Note that each mapping function is used for communicating with different operating system. As a new RTOS 20 is installed, the advanced IPMI system 10 can adjust its operating environment by using a proper mapping function, preventing from incompatible environment with previous OS.

Moreover, the application units of an exemplary embodiment of the claimed invention IPMI core subsystem 18 further comprise an I²C sensor 500 having an electrically erasable programmable read only memory (EEPROM) 550 for storing a sensing event of a physical change in a host system, a cache unit 420 (such as a random access memory, RAM) for accessing and storing the sensing event from the EEPROM 550 of the I²C sensor 500, a memory control unit 400 for periodically polling a new sensing event in the EEPROM 550 of the I²C sensor 500, allowing the cache unit 420 to access and store the sensing event, a plurality of I²C drivers 545 for driving different I²C sensors 500, and an I²C driver management unit 540 for managing the plurality of I²C drivers 545 with an application interface.

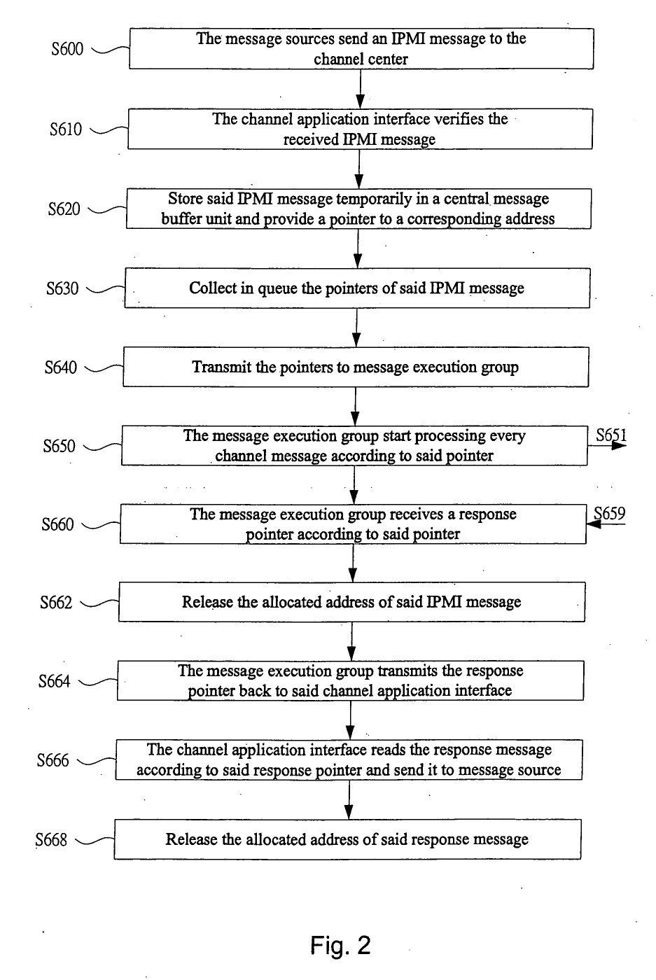

As FIG. 2 shows, the method of the exemplary embodiment of an advanced IPMI system with multi-message processing and configurable capability, optimally used among message sources, comprises:
Step S600: As the message source sends an IPMI message to the channel center 100, let at least one corresponding channel application interface 102 (such as the IPMB application interface) receive the IPMI message.
Step S610: The channel application interface 102 verifies the received IPMI message.
Step S620: Store the IPMI message temporarily in a central message buffer unit 200 and provide a pointer to the corresponding address stored IPMI message.
Steps S630, S640: Collect in queue the pointers of the IPMI messages by a message collection unit 220 and transmit the pointers to the message execution group 300.
Step S650: The message execution group 300 starts processing every channel message according to the pointer.

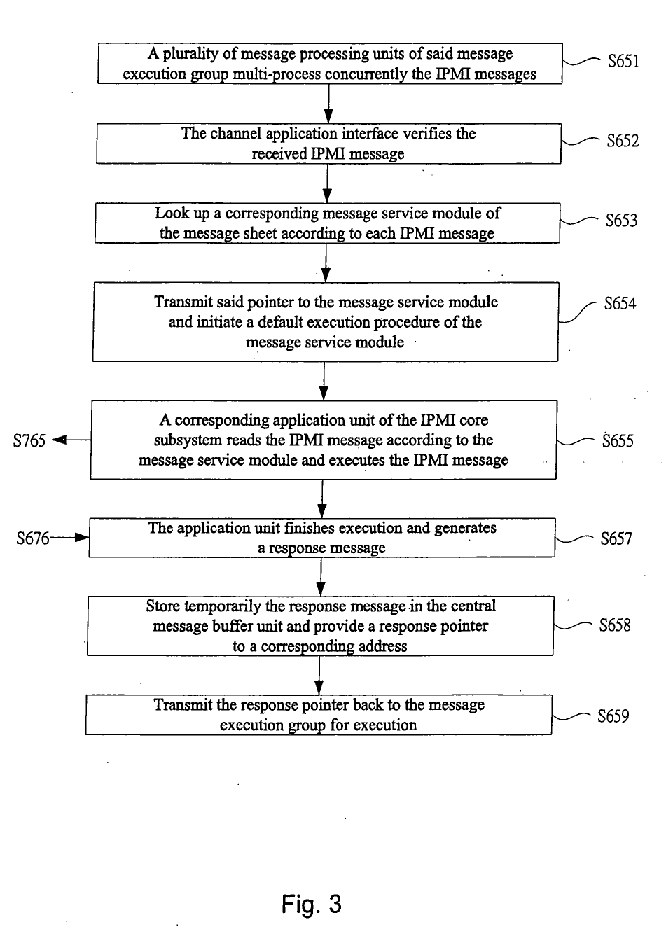

Next please see the step S651 in FIG. 3.
Step S651: A plurality of programmable-configured message processing units 302 of the message execution group 300 multi-process concurrently the IPMI messages.
Step S652: Each message processing unit 302 reads an IPMI message from the central message buffer unit 200 according to the pointer.
Step S653: According to each IPMI message, the message processing unit 302 looks up a corresponding message service module 306 of a programmable-configured message sheet 304.
Step S654: The message processing unit 302 transmits the pointer to the message service module 306 and initiates a default execution procedure of the message service module 306.
Step S655: When executing the execution procedure of the message service module 306, the message processing unit 302 transmits the pointer to an application unit through the message service module 306 and instructs the application unit for reading according to the pointer the IPMI message from the central message buffer unit 200 and executing the IPMI message.
Step S657: The application unit finishes execution and generates a response message.
Step S658: Store temporarily the response message in the central message buffer unit 200 and provide a response pointer to the corresponding address of the stored response message.
Step S659: The application unit transmits the response pointer back to the message processing unit 302 of the message execution group 300 for execution.

Then please turn back to steps S660 and S662 in FIG. 2.
Steps S660, S662: The message processing unit 302 of the message execution group 300 receives the response pointer and releases the allocated address of the IPMI message in the central message buffer unit 200 according to the pointer.
Step S664: The message processing unit 302 of the message execution group 300 transmits the response pointer back to the channel application interface 102.
Step S666: Let the channel application interface 102 read the response message according to the response pointer and send it to message sources.
Step S668: The channel application interface 102 releases the allocated address of the response message in the central message buffer unit 200.

As FIG. 4 shows, a preferred embodiment of the method of the claimed invention advanced IPMI system further comprises an application unit (such as memory control unit 400) executing the IPMI message in detail, which includes:
Step S670: The memory control unit 400 receives a read request so as to obtain a sensing event of a physical change in a host system from store by a sensor unit 500 in an electrically erasable programmable read only memory (EEPROM) 550.
Step S672: The memory control unit 400 detects whether the sensing event is stored in the cache unit 402. If the sensing event is stored in the cache unit 402, go to Step S673, or go to Step S675.
Step S673: When detecting the sensing event stored in the cache unit 420, the memory control unit 400 reads the sensing event from the cache unit 420.
Step S675: When not detecting the sensing event stored in the cache unit 420, the memory control unit 400 reads the sensing event from the EEPROM 550 of the sensor unit 500 and controls the cache unit 402 to store the sensing event.
Step S676: Generate a response message in response to the detection of the sensing event.

In summary, the claimed invention provides an advanced intelligent platform management interface (IPMI) system with multi-message processing and configurable capability and the method of the same comprise the following advantages:

(1) The claimed invention utilizes a central message buffer unit for temporarily storing an IPMI message. Only a pointer to a corresponding address of the IPMI message is transmitted between units, lowering memory usage and cost and reducing execution time, and thus raising the overall performance of the IPMI system.

(2) The claimed invention utilizes a plurality of programmable-configured message processing units 302 that are able to be easily pre-configured and installed by the user to concurrently multi-process the IPMI messages. It also presents most functions in sheet form so that a user may predetermine needed parameters. And modularization of the procedures for executing the IPMI messages enhances the expandability and configurability of the system.

(3) The claimed invention utilizes a memory control unit for periodically polling an electrically erasable programmable read only memory (EEPROM) of a sensor unit, thus allowing the cache unit to access in advance a sensing event, store it, and quickly access the sensing event of the I²C sensors.

(4) The claimed invention utilizes an operating system (OS) management module and a hardware management module for allowing the IPMI system to function with different OS and baseboard management controllers (BMC), and thus is capable of functioning in different hardware environments.

Those skilled in the art will readily observe that numerous modifications and alterations of the claimed device and method may be made while retaining the teachings of the invention. Accordingly, the above disclosure should be construed as limited only by the metes and bounds of the appended claims.

What is claimed is:

1. An advanced intelligent platform management interface (IPMI) system with multi-message processing and configurable capability, said advanced IPMI system comprising:
a sensor unit having an programmable memory device which stores a sensing event of a physical change in a host system;
a cache unit for accessing and storing said sensing event in said programmable memory device of said sensor unit; and
a memory control unit for detecting said sensing event storing in said cache unit, and for controlling said cache unit to store said detected sensing event.

2. The advanced IPMI system of claim 1 wherein said cache unit is a random access memory (RAM).

3. The advanced IPMI system of claim 1 wherein said sensor unit comprises at least one I²C sensor.

4. The advanced IPMI system of claim 3 wherein said sensor unit further comprises: a plurality of I²C drivers for driving different I²C sensors; and an I²C driver management unit for managing said plurality of I²C drivers.

5. The advanced IPMI system of claim 1 wherein said programmable memory device is an electrically erasable programmable read only memory (EEPROM).

6. The advanced IPMI system of claim 1 being used among a plurality of message sources,

7. The advanced IPMI system of claim 6 wherein said message sources comprise a host system and/or an operating terminal.

8. A method for an advanced intelligent platform management interface (IPMI) system with multi-message processing and configurable capability, said method comprising:
receiving a request from at least one message source for obtaining a sensing event of a physical change in a host system; detecting whether said sensing event is stored in a cache unit; reading said sensing event from the cache unit if said sensing event is stored in said cache unit; and generating a message in response to the detection of the sensing event.

9. The method of claim 8, further comprising the steps of: reading said sensing event from an programmable memory device if said sensing event is not stored in said cache unit; and controlling said cache unit to store said sensing event.

10. The method of claim 9 wherein said cache unit is a random access memory (RAM).

11. The method of claim 9 wherein said sensor unit comprises at least one I²C sensor.

12. The method claim 11 wherein said sensor unit further comprises: a plurality of I²C drivers for driving different I²C sensors; and an I²C driver management unit for managing said plurality of I²C drivers.

13. The method of claim 9 electrically erasable programmable read only memory (EEPROM)

14. The method of claim 9 wherein said method is used among a plurality of message sources.

15. The method of claim 14 wherein said message sources comprise a host system and/or an operating terminal.
